(19) United States
(12) Patent Application Publication
(10) Pub. No.: US 2015/0026224 A1
(43) Pub. Date: Jan. 22, 2015

(54) ELECTRONIC DEVICE, METHOD AND STORAGE MEDIUM

(71) Applicant: Kabushiki Kaisha Toshiba, Tokyo (JP)

(72) Inventors: Sachie Yokoyama, Ome-shi (JP); Eita Shuto, Tokyo (JP)

(73) Assignee: Kabushiki Kaisha Toshiba, Tokyo (JP)

(21) Appl. No.: 14/256,443

(22) Filed: Apr. 18, 2014

(30) Foreign Application Priority Data
Jul. 22, 2013 (JP) 2013-152075

(51) Int. Cl. G06F 17/30; G06F 17/21

(52) U.S. Cl. CPC G06F 17/30091; G06F 17/218
USPC 707/812; 715/760

(57) ABSTRACT

According to one embodiment, an electronic device includes a processor and a display processor. The processor is configured to store, in a storage, first information and second information. The first information regards a plurality of web pages viewed in a process of reaching a first web page. The second information regards a first clip corresponding to an area specified in the first web page. The display processor is configured to execute a process for displaying a plurality of clips comprising the first clip, and to execute, if the first clip is selected by a user, a process for displaying the plurality of web pages viewed in the process of reaching the first web page.

### CROSS-REFERENCE TO RELATED APPLICATIONS

This application is based upon and claims the benefit of priority from Japanese Patent Application No. 2013-152075, filed Jul. 22, 2013, the entire contents of which are incorporated herein by reference.

### FIELD

Embodiments described herein relate generally to an information processing technique suitable for an electronic device including a function of browsing web pages put on view on the Internet.

### BACKGROUND

In recent years, on the Internet, an untold number of web pages have been on view. Thus, the web page to be viewed can be changed indefinitely from one web page to another by tracing links. Inevitably, users tend to view a larger number of web pages. In view of such circumstances, various mechanism, etc., for enabling users to efficiently review web pages (already viewed by the users) have been proposed.

Also, in recent years, a larger number of electronic devices have been provided which incorporate touch screen displays in order for users to easily perform an input operation. For example, in such an electronic device, the user can do handwriting input onto the touch screen display with, e.g., a pen, in such a manner to surround an necessary part of a web page displayed on the touch screen display, in order to have the necessary part cut and stored in a memory. The cut and stored part of the web page is referred to as a clip or a scrap.

It should be noted that with respect to the cut and stored part, the fact is that with passage of time, it becomes more difficult for the user to recall, e.g., why the user had the part stored in the memory. Although a browser includes a function of displaying a browse history, the function merely displays all viewed web pages, at a time and in chronological order. That is, even if the browse history is displayed, it does not enable the user to grasp at a glance, e.g., which of the web pages the user viewed thoroughly or long time in process of reaching a web page containing the above cut and stored part.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an appearance of an electronic device according to an embodiment.

FIG. 2 is an exemplary block diagram of a system configuration of the electronic device according to the embodiment.

FIG. 3 is an exemplary view for explaining the case where images are successively changed and displayed in the electronic device according to the embodiment, in the case where a tag is added to a document (web page) from which a clip is extracted.

FIG. 4 is an exemplary block diagram of functional structures of programs executed by the electronic device according to the embodiment.

FIG. 5 is an exemplary view for showing an example of clip data which is used in the electronic device according to the embodiment.

FIG. 6 is an exemplary view for explaining a series of processes carried out by the electronic device according to the embodiment, which include a clip process, a clip searching process and a corrective display process.

FIG. 7 is an exemplary first view for explaining a clip list view window provided to a user by the electronic device according to the embodiment.

FIG. 8 is an exemplary second view for explaining the clip list view window provided to the user by the electronic device according to the embodiment.

FIG. 9 is an exemplary view for showing a relationship between browsing of the user and a collective display for clips in the electronic device according to the embodiment.

FIG. 10 is an exemplary first flowchart of an example of a procedure of an operation regarding the collective display in the electronic device according to the embodiment.

FIG. 11 is an exemplary second flowchart of the example of the procedure of the operation regarding the collective display in the electronic device according to the embodiment.

FIG. 12 is an exemplary third flowchart of the example of the procedure of the operation regarding the collective display in the electronic device according to the embodiment.

### DETAILED DESCRIPTION

Various embodiments will be described hereinafter with reference to the accompanying drawings.

In general, according to one embodiment, an electronic device includes a processor and a display processor. The processor is configured to store, in a storage, first information and second information. The first information regards a plurality of web pages viewed in a process of reaching a first web page. The second information regards a first clip corresponding to an area specified in the first web page. The display processor is configured to execute a process for displaying a plurality of clips comprising the first clip, and to execute, if the first clip is selected by a user, a process for displaying the plurality of web pages viewed in the process of reaching the first web page.

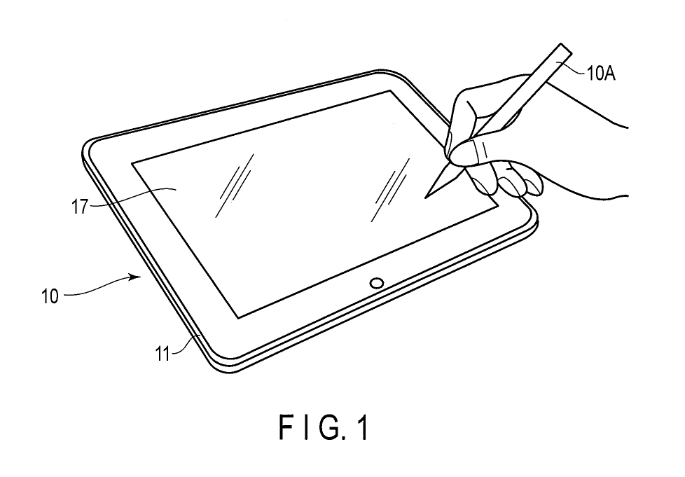

FIG. 1 is an exemplary perspective view of an appearance of an electronic device according to an embodiment. The electronic device is e.g., a portable electronic device onto which handwriting input can be done by a pen or a finger of a user. The electronic device may be provided as a tablet computer, a notebook personal computer, a smart phone, a PDA or the like. The following explanation is given with respect to the case where the electronic device is provided as a tablet computer 10.

The tablet computer 10 is a portable electronic device referred to a tablet or slate computer. The tablet computer 10 may function as a terminal for use in using, e.g., web browsing, electronic mail and social network service (SNS). The tablet computer 10, as shown in FIG. 1, includes a main body 11 and a touch screen display 17. The touch screen display 17 is attached to the main body 11 such that it is laid over an upper surface of the main body 11.

The main body 11 has a housing formed in the shape of a thin box. The touch screen display 17 incorporates a flat panel display and a sensor configured to detect the position of a pen or a finger which contacts a screen of the flat panel display. As the flat panel display, for example, a liquid crystal display (LCD) may be provided. As the sensor, for example, a capacitance-type touch panel or an electromagnetic induction type digitizer can be provided. The following explanation is given with respect to the case where two types of sensors, i.e., a digitizer and a touch panel, are both incorporated in the touch screen display 17.

The digitizer and the touch panel are provided in such a manner as to be laid over the screen of the flat panel display. The touch screen display 17 can detect not only a touch (contact) of a finger of a user to the screen, but a touch (contact) of a pen 10A to the screen. As the pen 10A, for example, an electromagnetic induction pen may be provided. On the touch screen display 17, the user can make various motions such as tapping, dragging, swiping and flicking with the pen 10A or a finger of the user.

Furthermore, the user can use the pen 10A to do handwriting input onto the touch screen display 17. During inputting by handwriting, a path of movement of pen 10A over the screen, i.e., a stroke of handwriting over the screen, is expressed as a line of painting in real time. As a result, a plurality of strokes (paths) of handwriting are displayed on the screen.

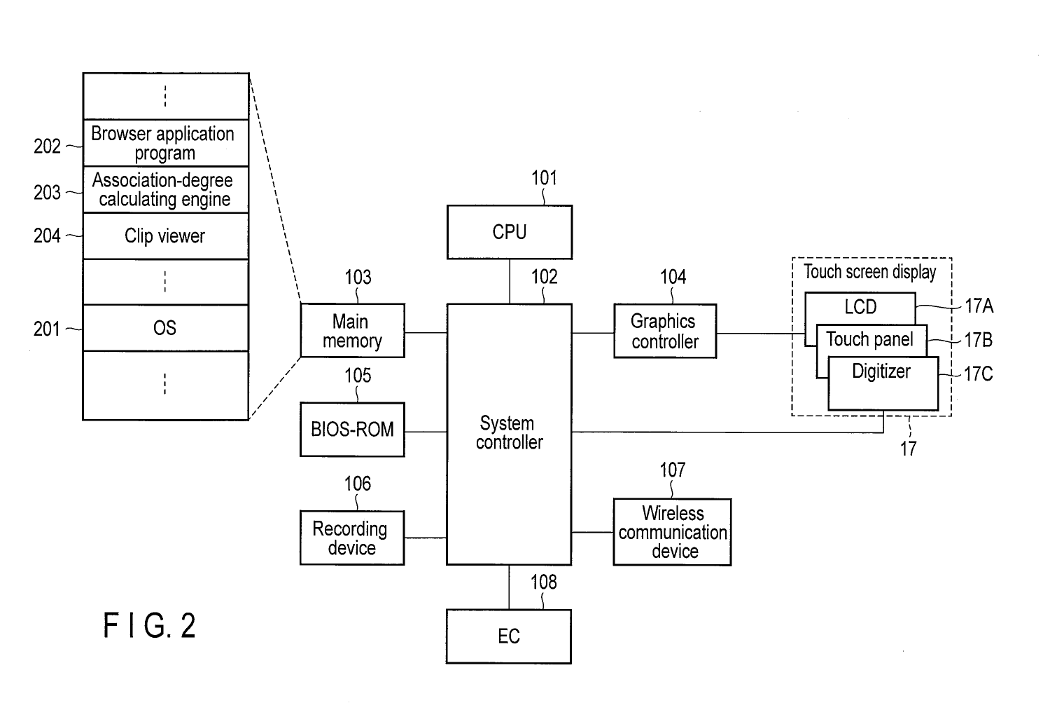

FIG. 2 is an exemplary block diagram of a system configuration of the tablet computer 10 according to the embodiment.

The tablet computer 10, as shown in FIG. 2, includes a CPU 101, a system controller 102, a main memory 103, a graphics controller 104, a BIOS-ROM 105, a recording device 106, a wireless communication device 107, an embedded controller (EC) 108, etc.

The CPU 101 is a processor configured to control operations of various modules provided in the tablet computer 10. The CPU 101 loads various programs from the recording device 106 into the main memory 103, and executes the loaded programs. The programs to be executed by the CPU 101 include an operating system (OS) 201 and various application programs. The application programs include a browser application program 202, an association-degree calculating engine 203, a clip viewer 204, etc.

The browser application program 202 includes a function of obtaining data of a web page from a web server, a function of displaying a web page on the screen, and a function of carrying out a clipping process. The clipping process is a process for storing in a storage medium a clip (clip data) including at least part of a displayed document. In other words, a clip is produced from a given document or part of the document. The kinds of documents to which the clipping function can be applied are not limited. As an example of such a document, a web page is present.

The association-degree calculating engine 203 includes a function of calculating the degrees of association between a plurality of documents (e.g., the degrees of association between a plurality of web pages) based on texts contained in the documents. The clip viewer 204 includes a function of viewing a clip including at least part of a document. In other words, the clip viewer 204 can display a window (clip list view window) capable of viewing a plurality of clips stored in the storage medium. Each of the clips is data including an entire document such as a web page or part of the document.

The CPU 101 also executes a basic input/output system (BIOS) stored in the BIOS-ROM 105. The BIOS is a grogram for controlling hardware.

The system controller 102 is a device which connects a local bus of the CPU 101 and various components. Also, the system controller 102 incorporates a main controller configured to perform an access control of the main memory 103. In addition the system controller 102 includes a function of communicating with the graphics controller 104 through a serial bus.

The graphics controller 104 is a display controller configured to control an LCD 17A used as a display monitor of the tablet computer 10. A display signal produced by the graphics controller 104 is sent to the LCD 17A. The LCD 17A displays an image on the screen in response to the display signal. At an upper layer of the LCD 17A, a touch panel 17B is provided as a first sensor configured to detect the position of a finger contacting the screen. At a lower layer of the LCD 17A, a digitizer 17C is provided as a second sensor configured to detect the position of the pen 10A contacting the screen. The touch panel 17B is a capacitance type of pointing device configured to do input onto the screen of the LCD 17A. The position, movement, etc. of the finger contacting the screen are detected by the touch panel 17B. The digitizer 17C is an electromagnetic induction type of pointing device configured to do input onto the screen of the LCD 17A. The position, movement, etc. of the pen 10A contacting the screen are detected by the digitizer 17C.

The OS 201 issues, in corporation with a driver program for controlling the touch panel 17B, an input event indicating a touch of a finger to the screen and the position of the finger. Also, the OS 201 issues, in corporation with a driver program for controlling the digitizer 17C, an input event indicating a touch of the pen 10A to the screen and the position of the pen 10A.

The wireless communication device 107 is a device configured to perform wireless communication such as wireless LAN or 3G mobile communication.

The EC 108 is a single-chip microcomputer including an embedded controller for power management. The EC 108 includes a function of turning on or off the tablet computer 10 in accordance with an operation of a power button by the user.

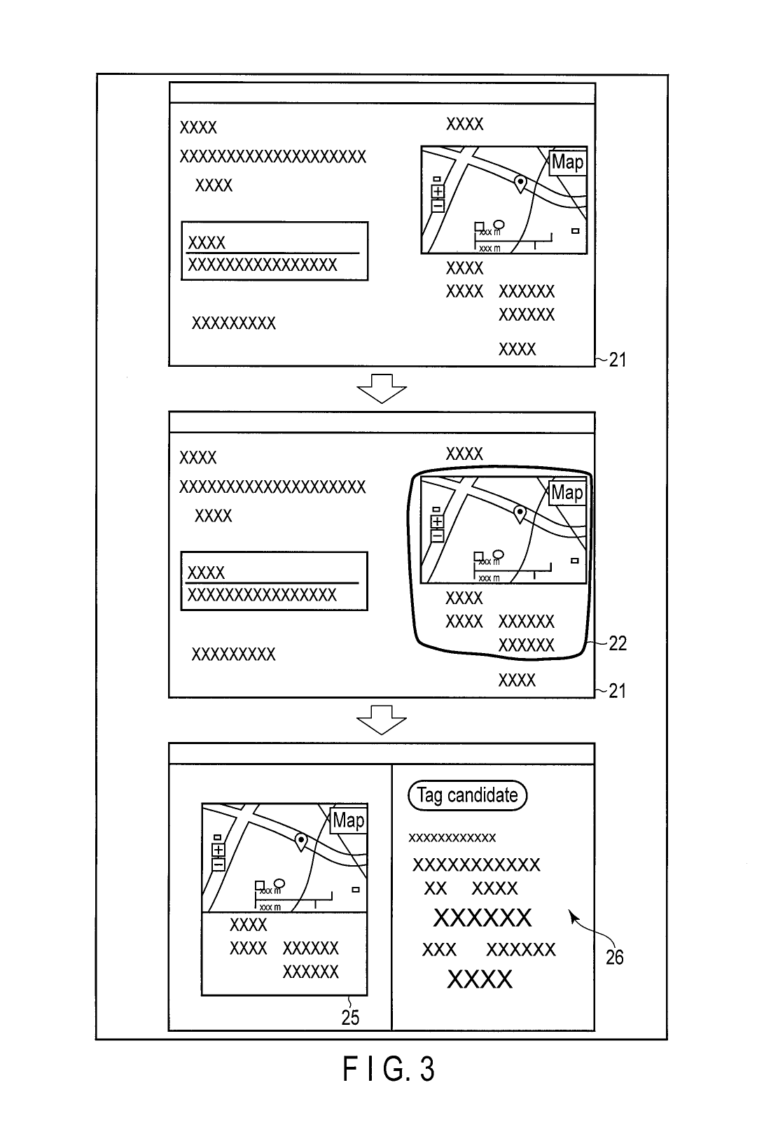

FIG. 3 shows an example of images to be displayed on the screen and changed at the time of extracting a clip from a displayed document (web page) and adding a tag to the clip.

On the screen, a document (web page) 21 including a text and an image is displayed. The user activates, e.g., the browser application program 202 and performs so-called Net-surfing to find a desired web page 21, and can have the desired web page 21 displayed on the screen.

There is a case where when being viewing a web page 21, in the web page 21, the user finds interesting part or part to be utilized later and thus stored in the storage medium. In this case, the user performs a clipping operation for indicating a clip range 22 in a document displayed, with a given kind of pointing device such as the touch screen display 17. In the embodiment, based on the clip range 22, a clip (web clip data) 25 including at least part of the document can be extracted. The clip (web clip data) is a combination of a structured text which is configured to indicate an entire HTML file obtained at a given URL or part of the HTML file, and image files and video files which are attached to the text.

Then, when the clip operation is performed, the extracted clip 25 and tag candidates (which will also be referred to as recommended tags) 26 associated with the clip 25 are displayed. The tag candidates 26 are candidates of tags to be associated with the clip 25. It should be noted that tags are additional information items to be associated with clips in order to arrange, search for and identify the clips. As such a tag, an arbitrary word can be used.

When the user performs an operation for selecting a tag to be associated with the clip 25 from among the displayed tag candidates 26 (e.g., the user taps the tag), the selected tag is automatically associated with the clip 25. The clip 25 and the tag associated therewith are stored in the storage medium.

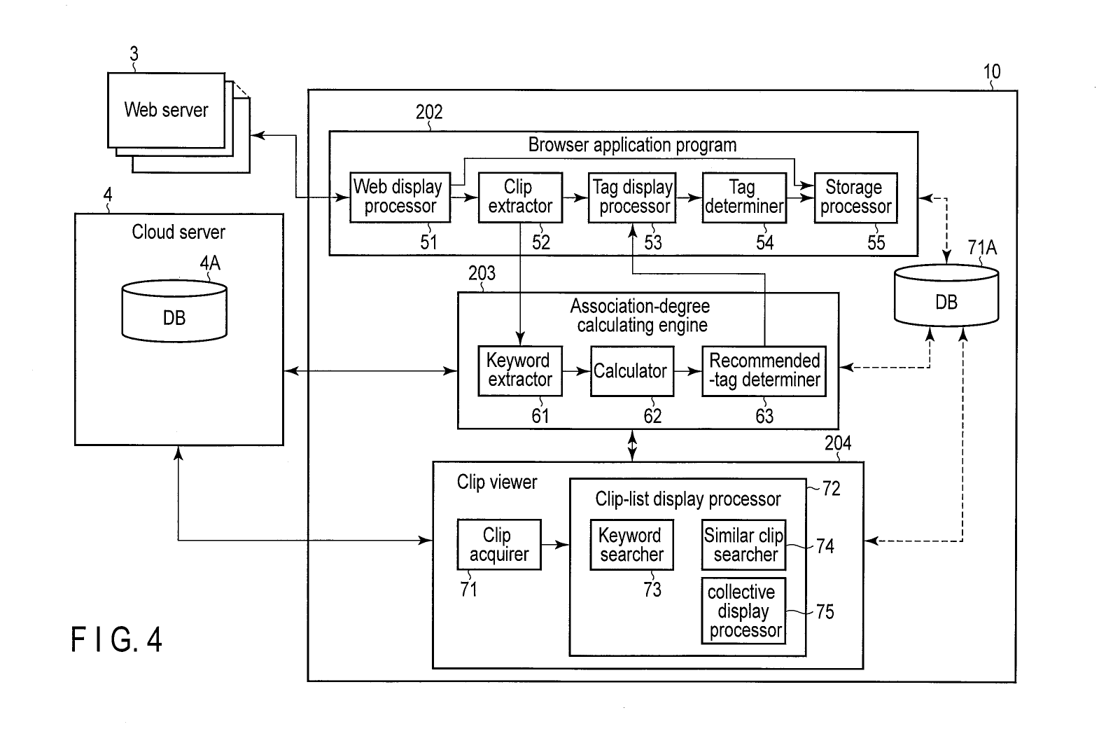

FIG. 4 shows functional structures of programs (the browser application program 202, the association-degree calculating engine 203 and the clip viewer 204) executed by the tablet computer 10.

First, the browser application program 202 will be explained. The browser application program 202 includes a web display processor 51, a clip extractor 52, a tag display processor 53, a dag determiner 54 and a storage processor 55.

The web display processor 51 receives data of a web page (web document) 21 from a web server 3, and displays the web page 21 on the LCD 17A based on the received data. To be more specific, for example, the web display processor 51 receives from the web server 3 an HTML file associated with a URL specified by the user. Then, the web display processor 51 analyzes the received HTML file, and displays the web page 21 associated with the received HTML file on the screen.

The clip extractor 52 selects a clip 25 including part of the displayed web page 21 from the web page 21 in accordance with a clip operation by the user. The clip operation is an operation for specifying an arbitrary range 22 in the web page 21 with a pointing device such as the touch panel 17B or the digitizer 17C. The clip extractor 52 extracts as a clip 25 a text or an image located in the range 22 of the web page 21, which is specified by the clip operation. The clip extractor 52 may extract a source code in that range 22 in an HTML source code associated with the web page 21, which is specified by the clip operation.

Furthermore, the clip extractor 52 outputs the displayed web page 21 (HTML file) to the association-degree calculating engine 203. The association-degree calculating engine 203 outputs a plurality of recommended tags 26 associated with the clip 25, which are determined by using the web page 21 to the browser application program 202 (tag display processor 53). The functional structure of the association-degree calculating engine 203 will be explained later.

The tag display processor 53 displays on the screen the clip 25 and the recommended tags 26 output by the association-degree calculating engine 203. With the recommended tags 26, respective scores indicating the degrees of association of the recommended tags 26 with the clip 25 may be associated. In this case, the tag display processor 53 may set sizes or positions in which the recommended tags 26 are displayed, in accordance with the respective scores associated with the recommended tags 26.

The tag determiner 54 determines a tag 26 to be associated with the clip 25 from the displayed recommended tags 26. If a tag 26 is selected from the recommended tags 26 by the user, the tag determiner 54 determines the selected tag 26 as a tag to be associated with the clip 25. If none of the recommended tags 26 is selected by the user, the tag determiner 54 may automatically determines one or more tags 26 from the recommended tags 26 as one or more tags (hidden tag) to be associated with the clip 25.

The storage processor 55 first stores in the storage medium, a web page (document) 21 displayed for time exceeding a predetermined time period, i.e., a web page viewed by the user thoroughly or for long time. As the storage medium, a database (DB) 4A on a cloud server 4 or a local DB 71A in the tablet computer 10 can be used. The local DB 71A is a storage region of, e.g., the recording device 106.

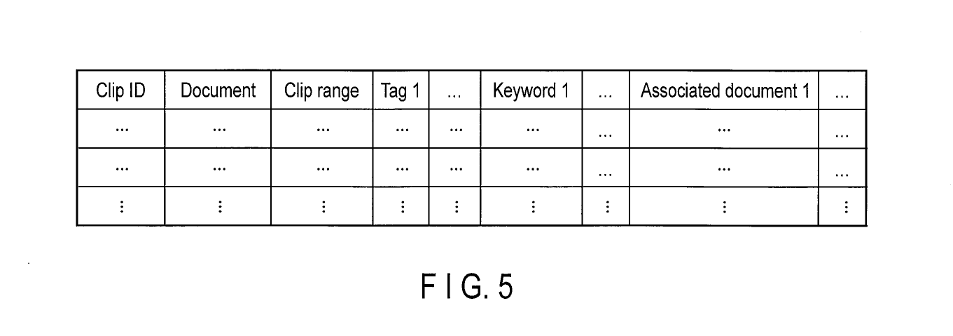

The storage processor 55 second stores in the storage medium, clip data indicating a web page (document) 21 from which the clip 25 is extracted, the clip 25 and the determined tag 26. The clip data also includes a web page 21 viewed for time exceeding the predetermined time period and stored in the storage medium, which is included in web pages 21 viewed by the user in process of reaching the web page (document) 21 from which the clip 25 is extracted. In addition to the above data, the storage processor 55 can also store, as described later with reference to FIG. 5, clip data further including other data regarding the clip 25 in the storage medium.

It should be noted that for example, in the case where a browsing operation for browsing the web pages 21 ends, the storage processor 55 may erase from the storage medium a web page (document) 21 which is stored in the storage medium as being viewed for time exceeding the predetermined time period, from time when a clip is extracted as a last extracted clip (time when the browsing operation starts, if no clip is extracted) to time when the browsing operation ends.

Next, the association-degree calculating engine 203 will be explained. The association-degree calculating engine 203 includes a keyword extractor 61, a calculator 62 and a recommended-tag determiner 63.

The keyword extractor 61 analyzes the web page 21 (HTML file) output by the browser application program 202 to extract a keyword from the web page 21. To be more specific, the keyword extractor 61 first analyzes with the Document Object Model (DOM) analysis the HTML source code associated with the web page 21 to extract text part (e.g., a title and a text) excluding, e.g., an HTML tag. The keyword extractor 61 morphemically analyzes the extracted text part to divide it into words (morpheme) and identify the part of speech of each of the words based on a dictionary. Then, the keyword extractor 61 extracts some characteristic ones (some representative ones) of the words obtained by the morphemic analysis with respect to the web page 21, as keywords associated with the web page 21.

For example, the keyword extractor 61 may extract a word which is a noun, from the words obtained by the morphemic analysis. Also, the keyword extractor 61 may extract a word which is a proper noun or a word put between brackets (e.g., ( )) or double quotation marks (“ ”), as a keyword.

Furthermore, in accordance with a prescribed rule, the keyword extractor 61 may extract a keyword from the words obtained by the morphemic analysis. In this rule, for example, it is prescribed that a word (e.g., the word “title”) appearing in all various documents (web pages) should not be extracted as a keyword.

Then, the calculator 62 calculates the degree of association between the extracted clip 25 and each of stored clips. For example, the calculator 62 calculates the degrees of association between a displayed web page 21 and web pages from which clips stored in the DB 4A in the cloud server 4 (or the local DB 71A) are extracted, to calculate the degrees of the association between the clips.

To be more specific, first, the calculator 62 reads a plurality of clip data stored in the DB 4A through a network. Alternatively, the calculator 62 may read a plurality of clip data from the local DB 71A.

FIG. 5 shows an example of a structure of clip data stored in the DB 4A or the DB 71A. The DB 4A or DB 71A includes a plurality of entries associated with a plurality of clips. In such a manner, the entries are associated with the clips (clip data items), respectively. Each of the entries includes clip ID, a document, a clip range, some tags, some keywords and some associated documents.

In an entry associated with a given clip, “clip ID” indicates identification information assigned to the clip, and “document” indicates a document (source) from which the clip is extracted. As such a document, various documents each containing a text, an image or video, such as web pages, are present. In “document”, for example, a file (e.g., an HTML file) corresponding to a web page from which the clip is extracted (e.g., an HTML source code in an HTML file) is set.

“Clip range” indicates a clip range of the document, which corresponds to the clip. For example, in the case where the clip is extracted from a web page based on an HTML file, in “clip range”, some elements in an HTML source code in the HTML file, which correspond to elements determined to fall within the clip range of the web page, are set.

Two kinds of information items set in “document” and “clip range” indicate the substance of clip data. Therefore, instead of the two kinds of information items in “document” and “clip range”, information including structured text part (structured text part for specifying the entire HTML file or part thereof) corresponding to the clip range, an image, a video file, etc., which are attached to the text part, may be stored.

“Tag” indicates a tag associated with the clip. A single entry may include a plurality of “tags”; that is, a plurality of tags may be associated with a single clip. “Keyword” indicates a keyword (e.g., an important word) extracted from the clip or the document associated with the clip. If a plurality of keywords are extracted from the clip or the document associated with the clip, the entry associated with the clip includes a plurality of “keywords”. “Associated document” indicates a document viewed by the user for time exceeding the predetermined time period, of documents viewed by the user in process of reaching the document from which the clip 25 is extracted. This document is also various documents containing a text or an image, such as web pages. That is, in “associated document” also, a file (e.g., an HTML file) corresponding to the above web page (viewed for time exceeding the predetermined time period in process of reaching the web page from which the clip 25 is extracted) is set.

With respect to each of the clip stored in the DB 4A (or the DB 71A), the calculator 62 calculates the degrees of association between the extracted clip 25 and the clips 25 stored in the DB 4A (or the DB 71A), using one or more first keywords associated with the displayed web page 21 and one or more second keywords included in clip data associated with the stored clips 25. The degree of association calculated by the calculator 62 increases as the number of keywords which are included in common in both the above one or more first keywords and the one or more second keywords increases. The degree of association is, e.g., 0, if no keyword is included in both the one or more first keywords and the one or more second keywords increases. That is, the calculator 62 calculates the degree of association between clips based on co-occurrence of keywords.

The recommended-tag determiner 63 may determine as the recommended tags 26 associated with the displayed web page 21, tags associated with stored clips whose degree of association with the displayed web page 21 is high.

The clip viewer 204 provides a function of browsing a group of clips (a plurality of clip data) stored in the DB 4A (or the DB 71A), using the stored group of clips. For example, the clip viewer 204 can search the group of clips based on a search keyword input by the user, for a clip to which the search keyword is associated as a tag, and display the clip searched for as the result of the search. Therefore, the user can efficiently search for a clip to be viewed, using a tag.

The clip viewer 204 includes a clip acquirer 71 and a clip-list display processor 72. The clip acquirer 71 acquires a plurality of clips (a plurality of clip data) stored in the DB 4A (or the DB 71A). Each of the clips, as described above, is produced from a document such as a web page or part of the document. The clip-list display processor 72 displays a window (clip list view window) capable of viewing the acquired clips on the LCD 17A.

The clip viewer 204 includes two types of searching functions to enable a desired clip to be easily found from a large number of clips stored in the DB 4A (or the DB 71A). One of the two types of searching functions is a keyword search. In the keyword search, one or more clips including a search keyword input by the user to a search key input area in the clip list view window are searched for. In this keyword search, as described above, a clip including a search keyword input by the user or a clip to which the search keyword is associated as a tag is provided to the user as the result of the search made using the search keyword. The keyword search is made by a keyword searcher 73 which is one of modules provided in the clip-list display processor 72.

The other of the two types of searching functions is a similar clip search. In the similar clip search, the search keyword input by the user is not used, and one or more clips associated with a clip specified by the user (i.e., one or more clips similar to the specified clip) is searched for, using the specified clip itself as a kind of search key. The user does not need to input a search keyword, and has only to specify one or more clips which somehow seem similar to a desired clip. The similar clip search is made by a similar clip searcher 74 which is one of the modules in the clip-list display processor 72.

In accordance with an operation by the user which is performed with respect to the clip list view window displayed on the screen, the similar clip searcher 74 selects as search keys, a group of first clips (one or more clips specified by the user) from a plurality of clips acquired from the DB 4A (or the DB 71A). Then, the similar clip searcher 74 calculates the degrees of association between each of clips other than the group of first clips and the group of first clips, using the association-degree calculating engine 20. Based on the calculated degrees of association, the similar clip searcher 74 searches for one or more second clips associated with the group of first clips. In this association-degree calculating process, as described above, the degree of association between clips is calculated based on the number of common keywords.

It should be noted that a tag, as well as a keyword, contains a word. Thus, in the case of calculating the degree of association between clips, this calculation may be performed based on not only a keyword (word) included in the above clips, but a tag associated with the clips. To be more specific, the degrees of association between each of the clips other than the group of first clips and the first clips can be calculated using a group of first words including one or more words included in the group of first clips and one or more tags associated with the group of first clips and a group of second words including one or more words included in each of the other clips and one or more tags associated with each of the other clips.

Furthermore, in order to enable the user to know visibly why each of the clips is stored, the clip viewer 204 provides a function of offering a collective display, i.e., a function of displaying a group of stored clips in a specific manner, not in a simple list form. As described above, clip data associated with each clip includes “associated document”, i.e., a web page viewed for time exceeding the predetermined time period in process of reaching a web page from which each clip is extracted. In the collective display, each clip and one or more web pages corresponding to “associated document” for each clip are displayed such that the web pages are arranged in chronological order, i.e., in order of time (with respect to the dates and times when they were viewed). Thus, the user can grasp how web pages were browsed when each clip was stored. This collective display is offered by a collective display processor 75 which is one of the modules in the clip-list display processor 72.

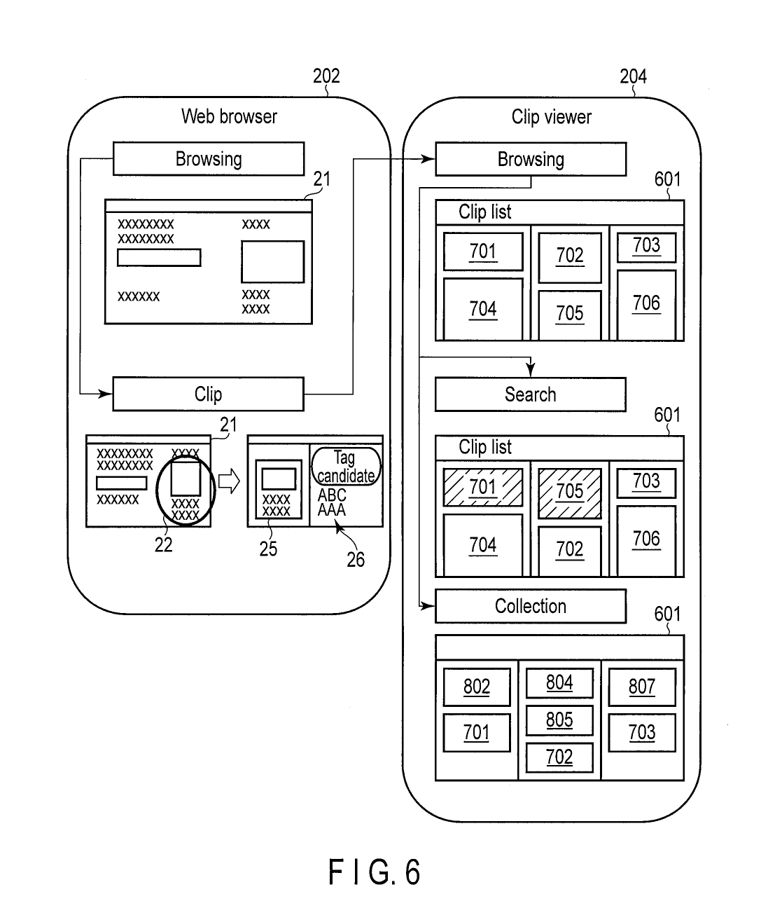

FIG. 6 is an exemplary view for explaining a series of processes carried out by the tablet computer 10.

The browser application program 202 executes a browsing process and the clipping process. In the browsing process, the browser application program 202 displays a web page 21. The clipping process is a process for storing in the storage medium a clip (web clip) produced from the web page 21 or part thereof. When a clipping operation for specifying a clip range 22 in the web page 21 is performed by the user, the browser application program 202 presents an extracted clip 25 and a plurality of tag coordinates (which will also be hereinafter referred to as recommended tags) associated with the clip 25 to the user. The browser application program 202 stores the clip 25 and tag candidates selected by the user in the storage medium, e.g., the DB 4A or the DB 71A. Furthermore, the browser application program 202 also stores in storage medium a web page 21 which is viewed for time exceeding the predetermined time period in process of reaching a web page 21 from which the clip 25 is extracted, due to a combination of the browsing process and the clip process.

The clip viewer 204 executes the browsing process for browsing a list of stored clips, the search process for searching for a desired clip and the corrective display process for displaying clips in such a manner as to make it possible to easily understand how they were browsed at time of storing the clips. In the browsing process, the clip viewer 204 displays a clip list view window 601 on the screen. The clip list view window 601 is a window for enabling a plurality of clips stored in the DB 4A to be viewed. FIG. 6 shows that the clips 701-706 are displayed in the clip list view window 601 on the screen.

In the searching process, at least one of the above keyword search and the similar clip search is made. The following explanation is given with respect to the case where the clip 701 is specified by the user as a clip to be applied in the similar clip search. In this case, the clip viewer 204 selects the specified clip 701 as a search key (query key), and makes the similar search for a clip associated with the clip 701. To be more specific, in the case shown in FIG. 6, the clip 705 is searched for as the clip associated with the clip 701. The clip viewer 204 may highlight the clip 705 in the clip list view window 601, it may scroll the clip list view window 601 such that the clip 705 appears in the clip list view window 601, or it may interchange the clip 705 and another clip (the clip 701 in the case shown in FIG. 6) with each other such that the clip 705 is displayed in uppermost part of the clip list view window 601.

In the collective display process, the clip viewer 204 displays each of a plurality of clips stored in the DB 4A and a web page or web pages viewed for time exceeding the predetermined time period before storing each of the clips, such that the web pages are arranged in chronological order. FIG. 6 shows by way of example that the clips 701-703 are displayed in the clip list view window 601. Also, it shows by way of example that web pages 802, 804, 805 and 807 are displayed in the clip list view window 601 in order to make it possible to understand that (a) at the time the clip 701 was stored, the web page 802 was viewed for long time; (b) at the time the clip 702 was stored, the web pages 804 and 805 were viewed in this order for long time; and (c) at the time the clip 703 was stored, the web page 807 was viewed for long time.

In the embodiment, as described with reference to FIG. 5, documents (HTML files) respectively associated with clips, not URLs associated with the clips, are stored in the DB 4A (or the DB 71A). Therefore, in any of the browsing process, the searching process and the collective process, if a motion (e.g., tapping) made on an arbitrary clip in the clip list view window 601 is detected, a web page from which the clip is extracted can be displayed based on the HTML file associated with the clip.

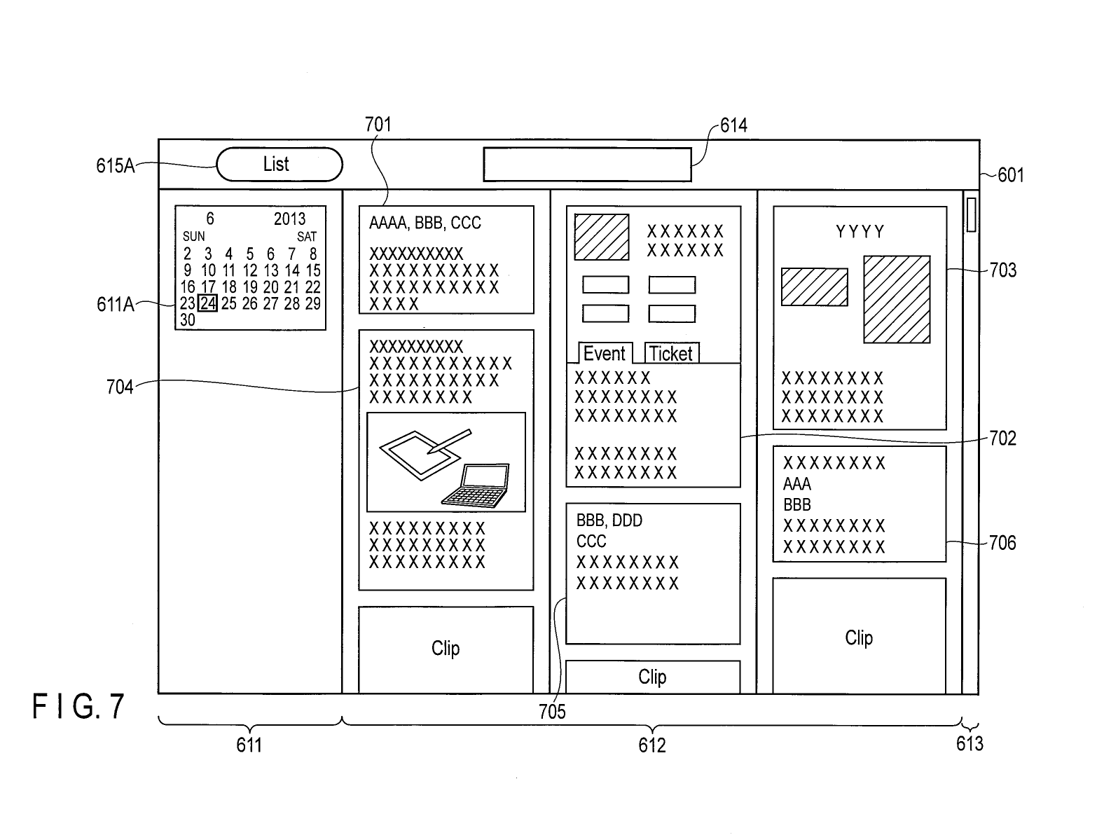

FIG. 7 shows an example of the clip list view window 601 presented by the browsing process of the clip viewer 204.

The clip list view window 601 includes a calendar display area 611, a clip-list display area 612, a vertical scroll bar 613, a search-keyword input box 614, a window switching button 615A, etc. The calendar display area 611 displays a calendar gadget 611A. The calendar gadget 611A can highlight a present data and time.

The clip-list display area 612 is a display area for listing stored clips. For example, in the clip-list display area 612, a plurality of clips (clips 701-706 in the case shown in FIG. 7) are displayed. Also, for example, a plurality of thumbnail images associated with the plurality of clips (clips 701-706 in the case shown in FIG. 7) may be displayed in the clip-list display area 612.

The clips 701-706 (thumbnail images associated with the clips 701-706) may be displayed in chronological order in the clip-list display area 612 such that for example, the later the date and time at which the clip was produced (it was stored), the higher the position of the clip in the clip-list display area 612. In the clip-list display area 612, the clips may be displayed such that they have the same breadth.

The clip viewer 204 can change clips to be displayed in the clip-list display area 612 by scrolling the clip-list display area 612 in a vertical direction in accordance with detection of an operation by the user (e.g., swiping with a finger of the user in a given position in the clip-list display area 612). Thereby, even if the case where clips the number of which is larger than that of clips simultaneously displayable in the clip-list display area 612 are stored in the DB 4A, the user can easily find an arbitrary clip by making a motion for scrolling the clip list view window 601 (the clip-list display area 612).

The search-keyword input box 614 is an input area to which a search keyword is to be input. The user can input an arbitrary keyword to the search-keyword input box 614 by operating a software keyboard. The clip viewer 204 can search for a clip having content associated with an input search keyword.

The window switching button 615A is an input area to which an instruction for switching the display of the clip list view window 601 from a list display to the collective display is to be given. The user can thus change the display of the clip list view window 601 to the collective display by performing a touch operation on the window switching button 615A. The window switching button 615A also serves to indicate that the present display of the clip list view window 601 is the list display.

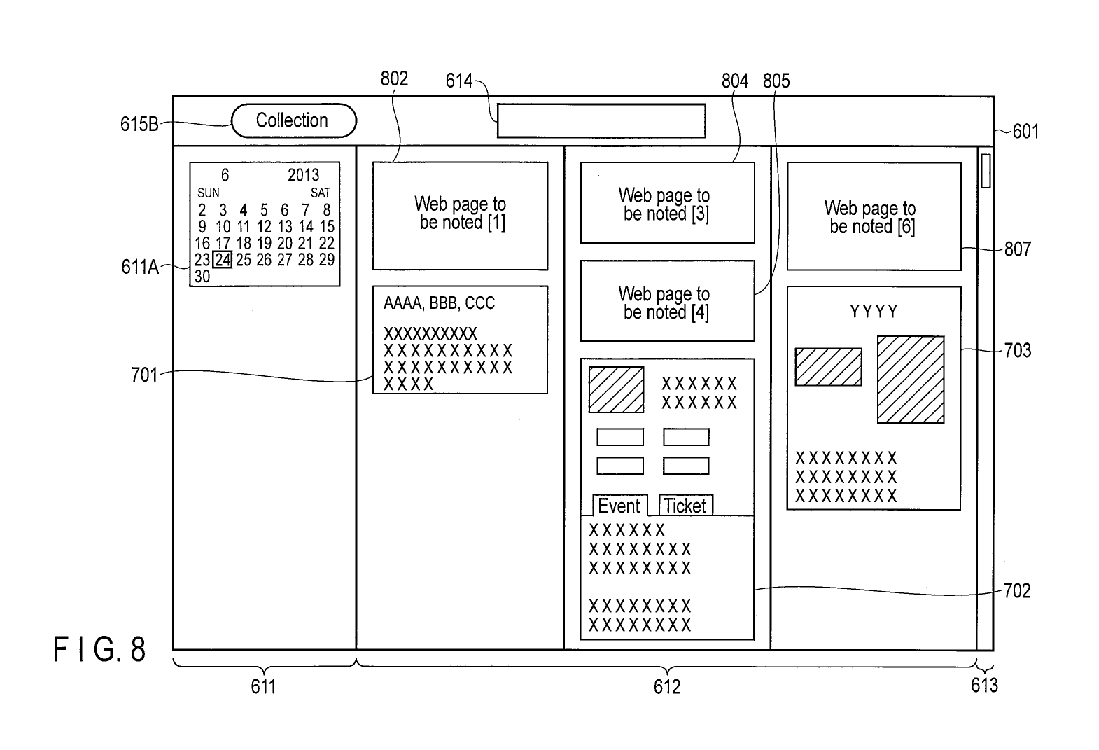

FIG. 8 shows an example of the clip list view window 601 presented by the collective display process of the clip viewer 204. In the clip list view window 601, a window switching button 615B is displayed in place of the window switching button 615A shown in FIG. 7. The window switching button 615B is an input area to which an instruction for switching the display of the clip list view window 601 from the collective display to the list display. The user can thus change the display of the clip list view window 601 to the list display by performing the touch operation on the window switching button 615B. The window switching button 615B also serves to indicate that the present display of the clip list view window 601 is the collective display.

Furthermore, in the clip list view window 601, for example, the clip-list display area 612 is divided into sections extending in the vertical direction, and clips are indicated in the sections, respectively. In each of the sections, a respective one of the clips and documents (web pages to be noted) viewed for long time before storing the respective one of the clips are displayed such that the documents are arranged in chronological order.

For example, in the case where the touch operation is performed on the window switching button 615A in the clip list view window 601 shown in FIG. 7, the clips 701, 702 and 703 are selected as clips to be displayed at the time of switching the display, in chronological order, i.e., in order of time, with respect to the dates and times when the clips were produced (the dates and times when they were stored), the dates and times being indicated in the clip list view window 601. Then, as shown in FIG. 8, in each of the sections, an associated one of the clips 701-703 and a web page or web pages viewed for long time before storing the associated clip are displayed such that the web pages are arranged in such a chronological order as stated above, in order to make it possible to understand that (a) at the time of storing the clip 701, the web page 802 was viewed for long time; (b) at the time of storing the clip 702, the web pages 804 and 805 were viewed in this order for long time; and (c) at the time of storing the clip 703, the web page 807 was viewed for long time.

Also, the clip viewer 204 can change clips to be displayed in the clip-list display area 612 by scrolling the clip-list display area 612 in a horizontal direction in accordance with detection of an operation by the user (e.g., swiping with a finger of the user in a given position in the clip-list display area 612). Furthermore, for example, even if the case where a larger number of web pages were viewed before a clip was stored, and not all the web pages can be simultaneously displayed in the clip-list display area 612, web pages to be displayed in the clip-list display area 612 can be changed by scrolling the clip-list display area 612 in the vertical direction in accordance with detection of an operation by the user.

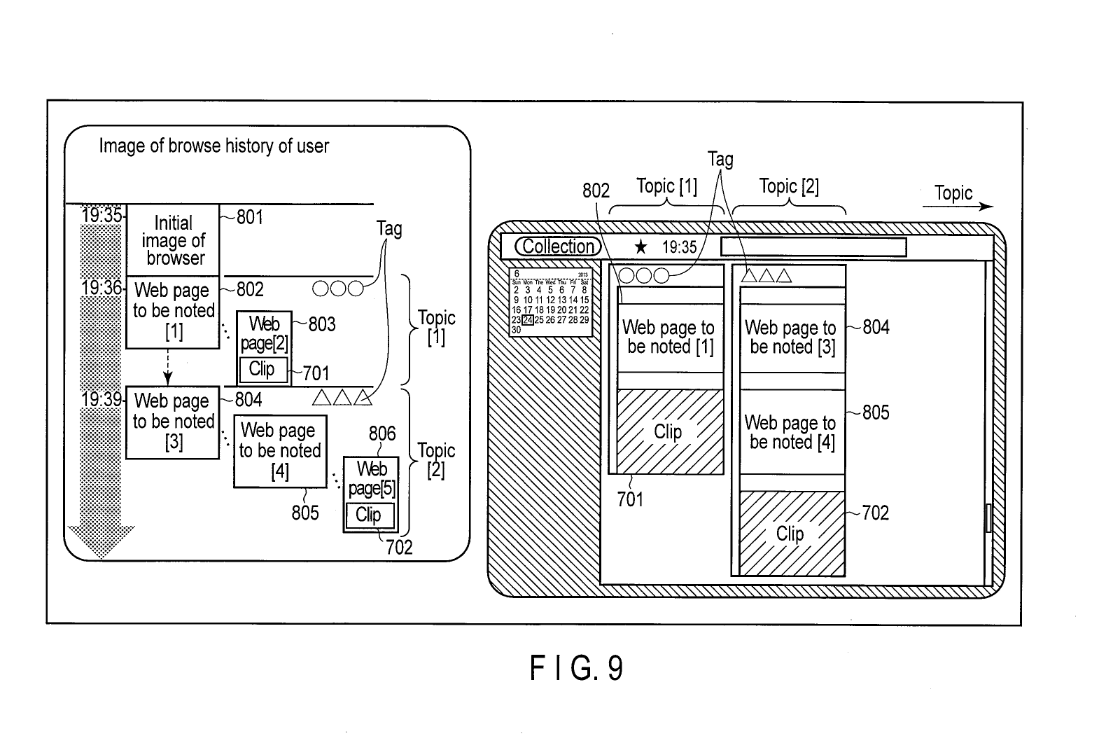

FIG. 9 is an exemplary view for showing a relationship between browsing of the user with the browser application program 202 and the collective display of the clip viewer 204 for clips.

When the browser application program 202 is activated, first, an initial image 801 set by the browser application program 202 is displayed on the screen. For example, suppose a web page of a search site is set as the initial image, and the browsing operation is started by inputting a search keyword to the web page.

Also, suppose a web page 802 was searched for, the user viewed the web page 802 for time exceeding the predetermined time period, and then after viewing other web pages, reached a web page 803, and stored a clip 701 extracted from the web page 803; after storing the clip 701, the user viewed a web page 804 searched for along with the web page 802, for time exceeding the predetermined time period; and the user continued browsing from the web page 804, reached a web page 806 after viewing other web pages including a web page 805, and then stored a clip 702 extracted from the web page 805. The web page 805 is a web page viewed for time exceeding the predetermined time period. The following explanation is given on the premise that a series of browsing steps carried out before storing each clip are handled as a single topic.

In the case where the clips 701 and 702 are stored in the above manner, the collective display of the clip viewer 204 for the clips 701 and 702 is offered as shown in FIG. 9. Specifically, in the collective display, topics are laterally indicated side by side, and with respect to each of the topics, a clip and a web page or web pages are vertically displayed such that the web pages are arranged in chronological order. To be more specific, the above display is offered in order to make it possible to understand that the clip 701 was stored after the web page 802 was viewed for long time; and the clip 702 was stored after the web pages 804 and 805 were viewed in this order for long time. In addition, in the collective display, with respect to each of the topics, in which a clip and a web page or web pages are displayed such that the web pages are arranged in chronological order, a tag is displayed as a tag associated with the clip.

The above structural feature enables the user to visibly understand why the user stored the clips 701 and 702, even if forgetting it after a lapse of time.

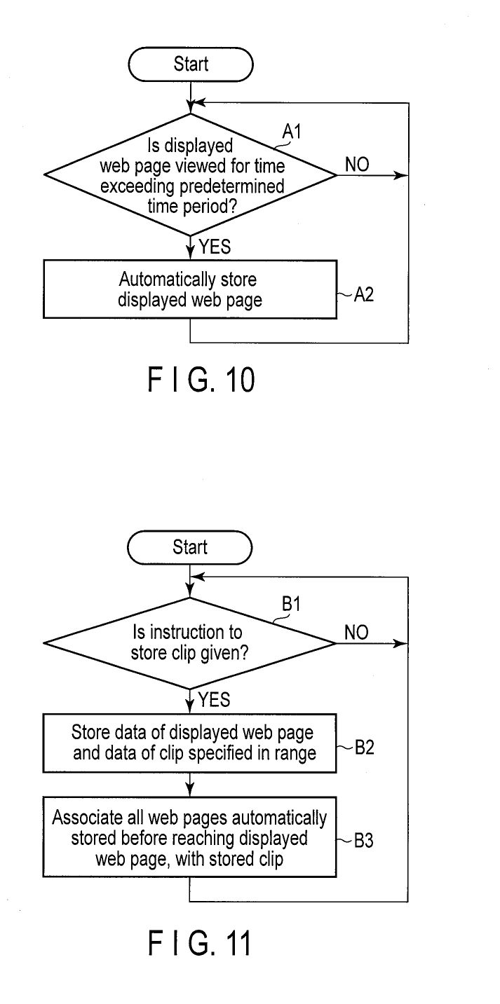

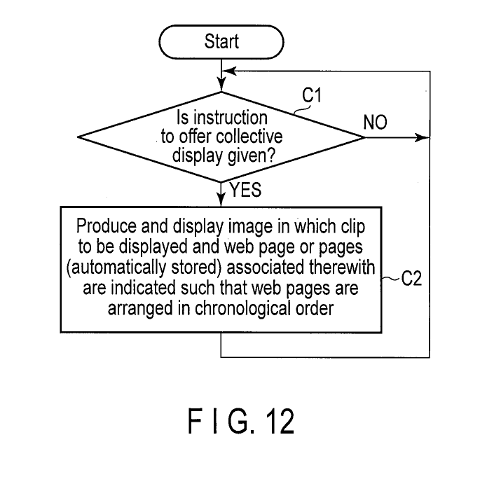

Next, a procedure of an operation of the tablet computer 10 regarding the collective display will be explained with reference to flowcharts of FIG. 10, FIG. 11 and FIG. 12.

The browser application program 202 monitors whether a web page displayed is viewed for time exceeding the predetermined time period or not (block A1 in FIG. 10). If it is viewed for time exceeding the predetermined time period (Yes in block A1 in FIG. 10), the browser application program 202 automatically stores the displayed web page (block A2 in FIG. 10).

Furthermore, when the browser application program 202 is instructed to store a clip (Yes in block B1 in FIG. 11), it first stores data of the displayed web page and data of a clip specified in range in the web page (block B2 in FIG. 11). Also, the browser application program 202 associates all web pages automatically stored in process of reaching the displayed web page, with the stored clip (block B3 in FIG. 11).

Then, when the clip viewer 204 is instructed to offer a collective display (Yes in block C1 in FIG. 12), it produces and displays an image in which a clip to be displayed and web pages (automatically stored) associated with the clip are indicated such that the web pages are arranged in chronological order (block C2 in FIG. 12).

In such a manner, the tablet computer 10 according to the embodiment enables the user to easily understand why stored information was stored.

Each of the processes according to the embodiment can be carried out by a computer program. Thus, the advantage of the embodiment can be easily obtained simply by installing the computer program on an ordinary computer via a computer-readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processor configured to store, in a storage, first information and second information, the first information regarding a plurality of web pages viewed in a process of reaching a first web page, the second information regarding a first clip corresponding to an area specified in the first web page; and
a display processor configured to execute a process for displaying a plurality of clips comprising the first clip, and to execute, if the first clip is selected by a user, a process for displaying the plurality of web pages viewed in the process of reaching the first web page.

2. The device of claim 1, wherein:
the processor is configured to store the first information regarding a web page viewed for time exceeding a first time period in the storage; and
the display processor is configured to arrange and display the web page, wherein the first information regarding the web page is stored in the storage by the processor, among the one or more web pages viewed in the process of reaching the first web page and associated with the first clip.

3. The device of claim 2, wherein the processor is configured to store the first information regarding a web page comprising the first clip in the storage.

4. The device of claim 1, wherein the display processor is configured to arrange clips and web pages viewed in the process of reaching first web pages comprising the clips, in such a way as to arrange display areas of the clips in a first direction of the screen, and as to arrange the clips and the web pages viewed in the process of reaching the first web pages comprising the clips in a second direction perpendicular to the first direction of the screen.

5. The device of claim 4, wherein the display processor is configured to execute a first scrolling display process of changing the clips to be displayed, by moving the display areas of the clips arranged in the first direction of the screen to the first direction, and a second scrolling display process of changing a clip or the web pages to be displayed, by moving the clip and the web pages viewed in the process of reaching one of the first web pages comprising the clip arranged in the second direction of the screen to the second direction.

6. The device of claim 4, wherein:
the processor is configured to store a selected keyword extracted from the first web page in the storage as a tag, in association with the second information regarding the first clip; and
the display processor is configured to display the keyword extracted and selected as the tag in the display areas of the clips.

7. A method of an electronic device, the method comprising:
Storing, in a storage, first information and second information, the first information regarding a plurality of web pages viewed in a process of reaching a first web page, the second information regarding a first clip corresponding to an area specified in a first web page; and
executing a process for displaying a plurality of clips comprising the first clip, and for displaying, if the first clip is selected by a user, the plurality of web pages viewed in the process of reaching the first web page.

8. The method of claim 7, wherein:
the storing the second information comprises storing the first information regarding a web page viewed for time exceeding a first time period in the storage; and
the executing the process comprises arranging and displaying the web page, wherein the first information regarding the web page is stored in the storage, among the one or more web pages viewed in the process of reaching the first web page and associated with the first clip.

9. The method of claim 8, wherein the storing the first information comprises storing the first information regarding the web page comprising the first clip in the storage.

10. The method of claim 7, wherein the executing the process comprises arranging clips and web pages viewed in the process of reaching the first web page comprising the first clip, in such a way as to arrange display areas of the clips in a first direction of the screen, and as to arrange the clips and the web pages viewed in process of reaching the first web page comprising the first clip in a second direction perpendicular to the first direction of the screen.

11. The method of claim 10, wherein the executing the process is capable of executing a first scrolling display process of changing the clips to be displayed, by moving the display areas of the clips arranged in the first direction of the screen to the first direction, and a second scrolling display process of changing a clip or the web pages to be displayed, by moving the clip and the web pages viewed in the process of reaching the first web page comprising the first clip arranged in the second direction of the screen to the second direction.

12. The method of claim 10, wherein:
the storing the second information comprises storing a selected keyword extracted from the first web page in the storage as a tag, in association with the second information regarding the first clip; and
the executing the process comprises displaying the keyword extracted and selected as the tag in the display areas of the clips.

13. A computer-readable, non-transitory storage medium having stored thereon a computer program which is executable by a computer, the computer program controlling the computer to function as:
a processor configured to store, in a storage, first information and second information, the first information regarding a plurality of web pages viewed in a process of reaching a first web page, the second information regarding a first clip corresponding to an area specified in a first web page; and
a display processor configured to execute a process for displaying a plurality of clips comprising the first clip, and to execute, if the first clip is selected by a user, a process for displaying the plurality of web pages viewed in the process of reaching the first web page.

14. The medium of claim 13, wherein:
the processor is configured to store the first information regarding a web page viewed for time exceeding a first time period in the storage; and
the display processor is configured to arrange and display the web page, wherein the first information regarding the web page is stored in the storage by the processor, among the one or more web pages viewed in the process of reaching the first web page and associated with the first clip.

15. The medium of claim 14, wherein the processor is configured to store the first information regarding the web page comprising the first clip in the storage.

16. The medium of claim 14, wherein the display processor is configured to arrange clips and web pages viewed in the process of reaching the first web page comprising the first clip, in such a way as to arrange display areas of the clips in a first direction of the screen, and as to arrange the clips and the web pages viewed in the process of reaching web the first page comprising the first clip in a second direction perpendicular to the first direction of the screen.

17. The medium of claim 16, wherein the display processor is capable of executing a first scrolling display process of changing the clips to be displayed, by moving the display areas of the clips arranged in the first direction of the screen to the first direction, and a second scrolling display process of changing a clip or the web pages to be displayed, by moving the clip and the web pages viewed in the process of reaching the first web page comprising the first clip arranged in the second direction of the screen to the second direction.

18. The medium of claim 16, wherein:
the processor is configured to store a selected keyword extracted from the first web page in the storage as a tag, in association with the second information regarding the first clip; and
the display processor is configured to display the keyword extracted and selected as the tag in the display areas of the clips.
